(19) United States
(12) Patent Application Publication
(10) Pub. No.: US 2020/0058002 A1
(43) Pub. Date: Feb. 20, 2020

(54) APPARATUSES AND METHODS FOR IMPROVED ACCOUNT PORTABILITY

(71) Applicant: Wells Fargo Bank, N.A., San Francisco, CA (US)

(72) Inventor: Chhanda Charan Patanaik, Bangalore (IN)

(21) Appl. No.: 16/105,118

(22) Filed: Aug. 20, 2018

(51) Int. Cl. G06Q 20/10; G06F 17/30

(52) U.S. Cl. CPC G06Q 20/10; G06F 17/30864

(57) ABSTRACT

A method, apparatus, and computer program product for improved account portability are provided. An example method includes receiving, by a computing device, a request for a new account. The method further includes associating a universal account number of a user with the request for the new account, wherein the universal account number uniquely identifies the user, and obtaining one or more account parameters associated with the universal account number of the user by the identification circuity of the computing device. The method includes determining, by compatibility circuity of the computing device, one or more new account parameters associated with the new account, and causing the new account to be opened with the one or more new account parameters.

### TECHNOLOGICAL FIELD

Example embodiments of the present invention relate generally to data management and, more particularly, to the use of universal user account numbers to improve account portability between organizations.

### BACKGROUND

Accounts provided by financial institutions (e.g., banks, credit unions, or the like) often utilize account numbers that are unique to a particular financial institution. However, customers or other users often move funds between financial institutions and also use accounts provided by different financial institutions simultaneously. Furthermore, these separate accounts may each be linked with various other third-party services such as a customer credit card, direct deposit, bill pay, or the like.

### BRIEF SUMMARY

Traditional methods for moving or otherwise transitioning between accounts provided by disparate financial institutions, however, have become increasingly burdensome despite the increasing ease of access and flexibility offered by emerging computing resources. For example, to move accounts from a first set of financial institutions to a second set of financial institutions, a user traditionally must individually contact each financial institution at which the user has an account and instruct the institution to close the account(s), and then must separately contact the new financial institution to which the user is transitioning and instruct the new financial institution to open a corresponding account. This process is further complicated by the fact that the user must also contact each third-party that is linked in some way with a newly closed account in order to ensure that those third-party linkages are migrated in order to ensure that account continuity is maintained.

To solve these issues and others, example implementations of embodiments of the present invention may utilize a universal account number (UAN) to provide improved bank number account portability (BANP) or otherwise eliminate the requirement for a customer to contact individual financial institutions separately in discrete operations. Embodiments of the present disclosure provide improved account portability techniques by associating requests for new accounts with a universal account number (UAN) of a user, where the universal account number uniquely identifies the particular user. This universal account number may be utilized to obtain account parameters associated with the universal account number (e.g., there may be default account parameters or the account parameters may be received from a financial institution providing a current account), determine one or more new account parameters, and open the new account with the new parameters. By using universal account numbers, the embodiments of the present disclosure may facilitate opening of new accounts in various financial institutions via a single request unassociated with a financial institution. The universal account number and associated account parameters provide improved bank number account portability (BANP) by allowing a user to (1) open a new account in a financial institution, (2) transfer accounts between institutions, and (3) open new accounts with equivalent or improved account parameters without required distinct operations to contact each of the institutions associated with the account migration. Furthermore, a universal account number that uniquely identifies particular users (e.g., operating as an encrypted token, in conjunction with user passwords, or the like) may also function to increase account security by providing uniform protection for all users regardless of selected financial institution.

Systems, apparatuses, methods, and computer program products are disclosed herein for improved bank number account portability (BANP). In one embodiment, with reference to the claimed method, a method for improved account portability is provided. The method may include receiving, by a computing device, a request for a new account. The method may further include associating, by identification circuitry of the computing device, a universal account number (UAN) of a user with the request for the new account, wherein the universal account number uniquely identifies the user and obtaining, by the identification circuity of the computing device, one or more account parameters associated with the universal account number of the user. The method may also include determining, by compatibility circuity of the computing device, one or more new account parameters associated with the new account, and causing the new account to be opened with the one or more new account parameters.

In some embodiments, associating the universal account number (UAN) with the new account request may also include querying, by the identification circuitry of the computing device, a universal account number database, and in response to querying the universal account number database, receiving a transmission from the universal account number database. In an instance in which the transmission from the universal account number database fails to identify the universal account number of the user, the method may include generating, by the identification circuitry, a new universal account number for the user, and associating the new universal account number for the user with the new account request. In an instance in which the transmission from the universal account number database identifies the universal account number of the user, the method may include associating the universal account number of the user with the new account request.

In some further embodiments, the method may in response to generating the new universal account number for the user, include generating a user profile associated with the new universal account number for the user.

In some cases, obtaining one or more account parameters associated with the universal account number (UAN) of the user may further include receiving, by input/output circuitry of the computing device, one or more account parameters inputs and populating, by the identification circuitry, the user profile with the one or more account parameters inputs.

In some other cases, obtaining the one or more account parameters further includes receiving, by the identification circuitry, the one or more account parameters from a universal account number database.

In some embodiments, obtaining the one or more account parameters further includes receiving the one or more account parameters from a first external device, wherein the first external device comprises a computing system associated with a first financial institution providing a current account associated with the universal account number (UAN) of the user. In such an embodiment, the method may further include identifying the first financial institution that provides the current account associated with the universal account number (UAN) of the user, translating, by translation circuitry of the computing device, between the universal account number of the user and a first user account number of the first external device, and querying, by the identification circuitry, the first external device for the one or more account parameters, wherein the one or more account parameters are obtained in response to querying the first external device.

In some other embodiments, the request for the new account comprises instructions for opening the new account with a second financial institution different from the first financial institution. In such an embodiment, the method may further include receiving instructions for closing the current account associated with the universal account number (UAN) of the user in the first financial institution and authenticating the instructions for closing the current account. Upon authenticating the instructions for closing the current account, the method may cause the current account to be closed in the first financial institution.

In other embodiments, the method may further include replacing, by the identification circuitry of the computing device, the one or more account parameters associated with the universal account number (UAN) with the one or more new account parameters associated with the new account.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates a system diagram including devices that may be involved in some example embodiments described herein.

FIG. 2 illustrates a schematic block diagram of example circuitry that may perform various operations, in accordance with some example embodiments described herein.

FIG. 3 illustrates an example flowchart for improved bank number account portability (BANP), in accordance with some example embodiments described herein.

FIG. 4 illustrates an example flowchart for associating a universal account number (UAN) with a user and generating a new universal account number (UAN) for the user, in accordance with some example embodiments described herein.

FIG. 5 illustrates an example flowchart for transitioning between a first financial institution providing a current user account and a new account provided by a second financial institution, in accordance with some example embodiments described herein.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. As used herein, the description may refer to a universal account server as an example “apparatus.” However, elements of the apparatus described herein may be equally applicable to the claimed method and computer program product. Thus, use of any such terms should not be taken to limit the spirit and scope of embodiments of the present invention.

### Definition of Terms

As used herein, the terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

As used herein, the term “comprising” means including but not limited to, and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refers to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the word “example” is used herein to mean “serving as an example, instance, or illustration.” Any implementation described herein as “example” is not necessarily to be construed as preferred or advantageous over other implementations.

As used herein, the terms “user device,” “first user device,” “mobile device,” “electronic device” and the like refer to computer hardware that is configured (either physically or by the execution of software) to access one or more services made available by a universal account server (e.g., apparatus or computing device of the present disclosure) and, among various other functions, is configured to directly, or indirectly, transmit and receive data. Example user devices may include a smartphone, a tablet computer, a laptop computer, a wearable device (e.g., smart glasses, smart watch, or the like), and the like. In some embodiments, a user device may include a “smart device” that is equipped with chip of other electronic device that is configured to communicate with the external device via Bluetooth, NFC, Wi-Fi, 3G, 4G, 5G, RFID protocols, and the like. By way of a particular example, a user device may be a mobile phone equipped with a Wi-Fi radio that is configured to communicate with a Wi-Fi access point that is in communication with the universal account server 200 or other computing device via a network.

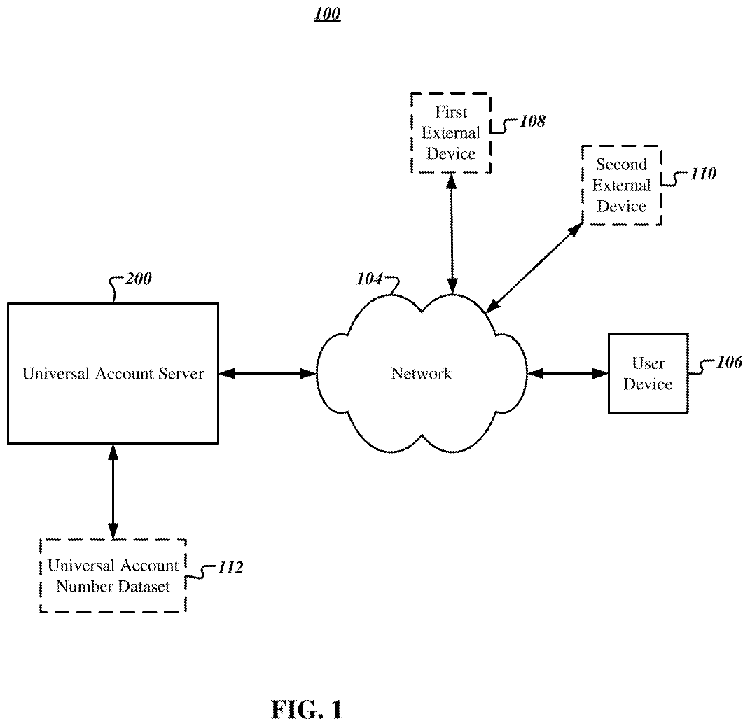

As used herein, the terms “user profile” and “first user profile” may refer to a collection of settings, configurations, identifiers, data, and information associated with a specific user. A user profile configured in accordance with the present invention may be accessible by one or more of software applications that are supported by the computing device (e.g., universal account server 200 in FIG. 1) or other external server or computing device (e.g., associated with a corporation, banking entity, or other 3^{rd} party) and, thus, may include application-specific preferences, settings, configurations, data, and information.

As used herein, the term “external device” refers to any object, device, or system which may be in network communication with the user device and/or the universal account server 200. For example, an external device may be an external server or computing device (e.g., associated with a corporation, banking entity, or other 3^{rd} party) that may request, receive, and/or provide data to or from one of the devices described above. By way of a more particular example, an external device may include a server of a bank, online vendor, or the like configured to provide an account to a user in the bank, online vender, or the like (e.g., via the universal account number techniques described herein).

As used herein, the term “universal account number database” refers to a data structure or repository for storing account numbers wherein each universal account number stored by the universal account number database uniquely identifies a particular user. In some embodiments, the universal account number database may further store one or more account parameters associated with a universal account number of a particular user. The universal account number data may be accessible by one or more software applications of the user device and/or universal account server.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

Having set forth a series of definitions called-upon throughout this application, an example system architecture and example apparatus is described below for implementing example embodiments and features of the present disclosure.

### Device Architecture and Example Apparatus

With reference to FIG. 1, an example system 100 is illustrated with an apparatus (e.g., a universal account server 200) communicably connected via a network 104 to a user device 106, and, in some embodiments, a first external device 108 and a second external device 110. The example system 100 may also include a universal account number database 112 that may be hosted by the universal account server 200 or otherwise hosted by devices in communication with the universal account server 200.

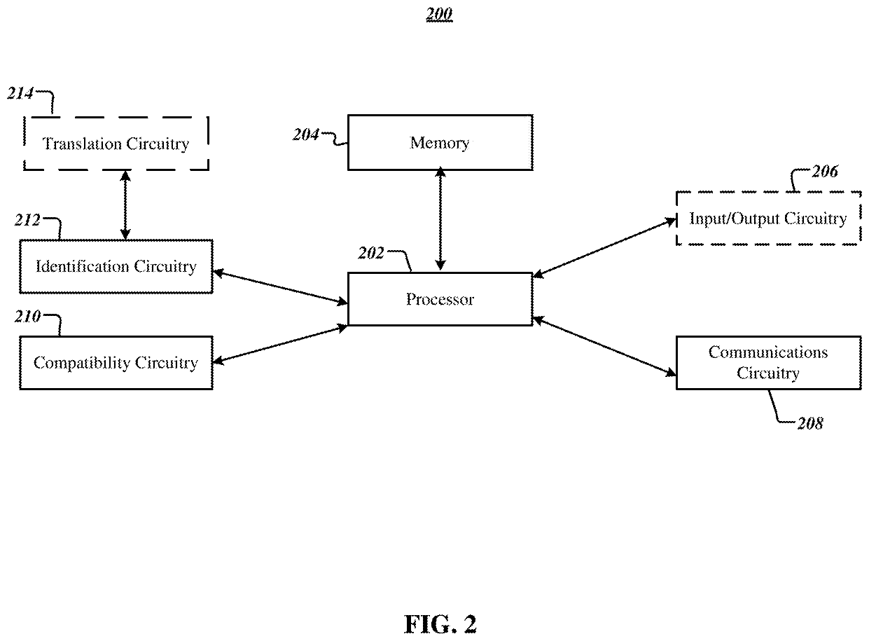

The universal account server 200 may include circuitry, networked processors, or the like configured to perform some or all of the apparatus-based (e.g., universal account server-based) processes described herein, and may be any suitable network server and/or other type of processing device. In this regard, universal account server 200 may be embodied by any of a variety of devices. For example, the universal account server 200 may be configured to receive/transmit data (e.g., universal account number data) and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs, but will nevertheless include at least the components illustrated in FIG. 2 and described in connection therewith. In some embodiments, the universal account server 200 may be located remotely from the user device 106, first external device 108, second external device 110, and/or universal account number database 112, although in other embodiments, the universal account server 200 may comprise the user device 106, first external device 108, second external device 110, and/or universal account number database 112. The universal account server 200 may, in some embodiments, comprise several servers or computing devices performing interconnected and/or distributed functions. Despite the many arrangements contemplated herein, the universal account server 200 is shown and described herein as a single computing device to avoid unnecessarily overcomplicating the disclosure. In some embodiments, one or more components of the universal account server 200 may be wholly or partially housed within one or more of the first user device 106, the first external device 108, or the second external device 110.

The network 104 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (e.g., network routers, switches, hubs, etc.). For example, the network 104 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the network 104 may include a public network, such as the Internet, a private network, such as an intranet, or combinations thereof, and may utilize a variety of networking protocols now available or later developed including, but not limited to TCP/IP based networking protocols.

The user device 106 may be associated with a first user and/or first user profile. Although a single user device associated with a corresponding user profile is shown, the example system 100 may include any number of user devices that may be associated with various users and/or user profiles. The user device 106 may be a cellular telephone (e.g., a smartphone and/or other type of mobile telephone), laptop, tablet, electronic reader, e-book device, media device, wearable, smart glasses, smartwatch, or any combination of the above.

The first external device 108, as defined above, may be associated with any entity that is not associated with the user device 106. By way of a more particular example, the external device 108 may include a server of a bank, online vendor, or other 3^{rd}-party configured to be in secure communication with the user device 106 via the network 104 (e.g., an authenticated session).

The second external device 110, as defined above, may also be associated with any entity that is not associated with the user device 106 or the first external device 108. By way of a more particular example, the second external device 108 may include a server of another bank, online vendor, or other 3^{rd}-party configured to be in secure communication with the user device 106 and/or the first external device 108 via the network 104 (e.g., an authenticated session). Although shown as two (2) external devices, the system 100 may include any number of external devices.

The universal account number database 112 may be stored by any suitable storage device configured to store some or all of the information described herein (e.g., memory 204 of the universal account server 200 or a separate memory system separate from the universal account server 200, such as one or more database systems, backend data servers, network databases, cloud storage devices, or the like provided by an external device (e.g., a banking entity or 3^{rd} party provider) or the user device 106). The universal account number database 112 may comprise data received from the universal account server 200 (e.g., via a memory 204 and/or processor(s) 202) or the user device 106, and the corresponding storage device may thus store this data.

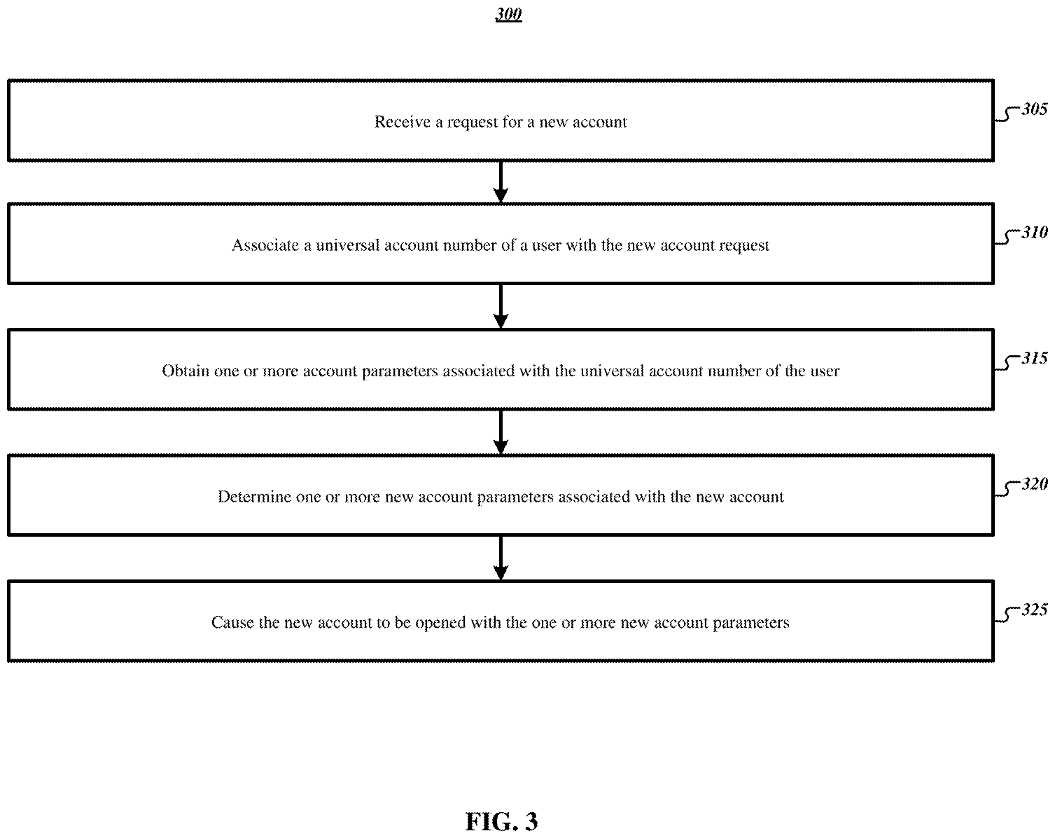

As illustrated in FIG. 2, the universal account server 200 may include a processor 202, a memory 204, input/output circuitry 206, and communications circuitry 208. Moreover, the universal account server 200 may include compatibility circuitry 210, identification circuitry 212, and, in some embodiments, translation circuitry 214. The universal account server 200 may be configured to execute the operations described below in connection with FIGS. 3-5. Although components 202-214 are described in some cases using functional language, it should be understood that the particular implementations necessarily include the use of particular hardware. It should also be understood that certain of these components 202-214 may include similar or common hardware. For example, two sets of circuitry may both leverage use of the same processor 202, memory 204, communications circuitry 208, or the like to perform their associated functions, such that duplicate hardware is not required for each set of circuitry. The use of the term “circuitry” as used herein includes particular hardware configured to perform the functions associated with respective circuitry described herein. As described in the example above, in some embodiments, various elements or components of the circuitry of the universal account server 200 may be housed within one or more of the first user device 106, the first external device 108, and/or the second external device 110. It will be understood in this regard that some of the components described in connection with the universal account server 200 may be housed within one of these devices, while other components are housed within another of these devices, or by yet another device not expressly illustrated in FIG. 1.

In some embodiments, the universal account server 200 may operate as a central repository and authenticator that is accessible by various user devices and external devices (e.g., computing systems associated with financial institutions). By way of example, the universal account server 200 may receive user data (e.g., number of accounts, financial institutions providing accounts, one or more account parameters, and/or the like) to be stored associated with a universal account number (UAN) of the respective user. As such, upon user request or instruction, any external device (e.g., computing system of a financial institution) may transmit a request to the universal account server 200 so as to receive information stored and authenticated by the universal account server 200. While described in some embodiments as a central repository and authenticator, in other embodiments, the universal account server 200 may be housed within and/or maintained by a single financial institution (e.g., as part of the computing system of the financial institution).

As noted above, the universal account server 200 may further operate, in such an embodiment, to authenticate not only user data stored by the universal account server 200, but also any request for a new account (or any other instruction or request) received by the universal account server 200. For example, the universal account server 200 operating as a central repository and authenticator may receive a request for a new account, as described hereafter with reference to FIG. 3, and may authenticate this request by, for example, contacting a user (via email, telephone call, SMS, or the like) to request confirmation from the user that the request for the new account is valid. As would be evident to one of ordinary skill in the art in light of the present disclosure, the universal account server 200 may utilize any authentication protocol or procedure (e.g., two or more factor authentication, biometric scanning, pseudo-random number generation, or the like) to authenticate a request for a new account. In some embodiments, as described hereafter with reference to FIG. 3, the request for a new account may also require additional inputs (e.g., the number and type of accounts provided by a first financial institution, a password associated with the first financial institution, or the like) in order to authenticate the request for a new account. In other embodiments, the universal account number (UAN) of the user may comprise an encrypted token or certificate that may (in conjunction with a user password in some embodiments) be used to authenticate the request for a new account. In some other embodiments, the universal account server 200 may further increase security by generating a set of passwords or tokens such that a first password may be provided to a first financial institution (e.g. providing a current account) and a second password may be provided to the user. In this way, the universal account server 200 may require that each of the first password and the second password be verified in order to authenticate a request for a new account.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the universal account server 200 may provide or supplement the functionality of particular circuitry.

In some embodiments, the processor 202 (and/or co-processor or any other processing circuitry assisting or otherwise associated with the processor) may be in communication with the memory 204 via a bus for passing information among components of the universal account server 200. The memory 204 may be non-transitory and may include, for example, one or more volatile and/or non-volatile memories. In other words, for example, the memory may be an electronic storage device (e.g., a non-transitory computer readable storage medium). The memory 204 may be configured to store information, data, content, applications, instructions, or the like, for enabling the universal account server 200 to carry out various functions in accordance with example embodiments of the present invention.

The processor 202 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the universal account server, and/or remote or “cloud” processors.

In an example embodiment, the processor 202 may be configured to execute instructions stored in the memory 204 or otherwise accessible to the processor 202. Alternatively or additionally, the processor 202 may be configured to execute hard-coded functionality. As such, whether configured by hardware or by a combination of hardware with software, the processor 202 may represent an entity (e.g., physically embodied in circuitry) capable of performing operations according to an embodiment of the present invention while configured accordingly. Alternatively, as another example, when the processor 202 is embodied as an executor of software instructions, the instructions may specifically configure the processor 202 to perform the algorithms and/or operations described herein when the instructions are executed.

The universal account server 200 further includes input/output circuitry 206 that may, in turn, be in communication with processor 202 to provide output to a user and to receive input from a user, user device, or another source (e.g., so as receive and/or transmit universal account number data). In this regard, the input/output circuitry 206 may comprise a display that may be manipulated by a mobile application. In some embodiments, the input/output circuitry 206 may also include additional functionality keyboard, a mouse, a joystick, a touch screen, touch areas, soft keys, a microphone, a speaker, or other input/output mechanisms. The processor 202 and/or user interface circuitry comprising the processor 202 may be configured to control one or more functions of a display through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the universal account server 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s). These signals may be transmitted by the universal account server 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

Identification circuitry 212 includes hardware components designed to associate a universal account number (UAN) of a user with a request for a new account, where the universal account number is configured to uniquely identify the user (e.g., each user is associated with only a single universal account number). The identification circuitry 212 may further include hardware components designed to obtain one or more account parameters associated with the universal account number of the user. Identification circuitry 212 may utilize processing circuitry, such as the processor 202, to perform its corresponding operations, and may utilize memory 204 to store collected information.

In some embodiments, the identification circuitry 212 may further include or be in communication with translation circuitry 214. For example, in an instance in which a first external device 108 (e.g., a computing device associated with a first financial institution) utilizes an account identification system, protocol, or the like that differs from the universal account number (UAN) of a particular user, the translation circuitry 214 may be configured to convert or translate between account number data received from the first external device 108 and the universal account number associated with the particular user. It will be understood that the translation circuitry 214 is optional insofar as some embodiments may not require conversion or translation between account data of an external device (e.g., account data of a financial institution) and the universal account number associated with a user. In one example, this may be the case by virtue of the nature of the account data system employed by the financial institution providing an account to the user. Said differently, the external device (e.g., a computing system) associated with a respective financial institution may utilize universal account numbers of a particular user as the user account data of the financial institution such that translation is unnecessary. As another example, where user account data for a financial institution is retrieved from a memory or from another device, the user account data may have already been translated into the universal account number of the associated user elsewhere, in which case the apparatus 200 need not include additional translation circuitry 214 to perform this function.

Compatibility circuitry 210 includes hardware components designed to determine one or more new account parameters associated with the new account (e.g., the request for a new account described above). The compatibility circuitry 212 may utilize processing circuitry, such as the processor 202, to perform its corresponding operations, and may utilize memory 204 to store collected information. By way of example, in some instances, the first external device 108 may include one or more account parameters associated with a current account provided by the first financial institution (e.g., supported by the first external device 108), and a second external device 110 (e.g., a computing device associated with a second financial institution) may not allow for or otherwise provide an account with one or more account parameters identical to the one or more account parameters associated with the current account of the first financial institution. In the way, the compatibility circuity 210 may determine one or more new account parameters (e.g., substantially equivalent account parameters) provided by the second financial institution.

It should also be appreciated that, in some embodiments, the compatibility circuitry 210, identification circuitry 212, or translation circuitry 214, may include a separate processor, specially configured field programmable gate array (FPGA), or application specific interface circuit (ASIC) to perform its corresponding functions.

In addition, computer program instructions and/or other type of code may be loaded onto a computer, processor or other programmable universal account server's circuitry to produce a machine, such that the computer, processor other programmable circuitry that execute the code on the machine create the means for implementing the various functions, including those described in connection with the components of universal account server 200.

As described above and as will be appreciated based on this disclosure, embodiments of the present invention may be configured as systems, methods, mobile devices, and the like. Accordingly, embodiments may comprise various means including entirely of hardware or any combination of software with hardware. Furthermore, embodiments may take the form of a computer program product comprising instructions stored on at least one non-transitory computer-readable storage medium (e.g., computer software stored on a hardware device). Any suitable computer-readable storage medium may be utilized including non-transitory hard disks, CD-ROMs, flash memory, optical storage devices, or magnetic storage devices.

### Example Operations for Improved Account Portability

FIG. 3 illustrates a flowchart containing a series of operations for improved bank number account portability (BANP). The operations illustrated in FIG. 3 may, for example, be performed by, with the assistance of, and/or under the control of an apparatus (e.g., universal account server 200), as described above. In this regard, performance of the operations may invoke one or more of processor 202, memory 204, input/output circuitry 206, communications circuitry 208, identification circuitry 212, compatibility circuitry 210, and/or translation circuitry 214.

As shown in operation 305, the apparatus (e.g., universal account server 200) includes means, such as input/output circuitry 206, communications circuitry 208, or the like, for receiving a request for a new account. In some example embodiments, the communications circuitry 208 may receive a request for a new account or an instruction to open a new account from a user device 106 and/or external device 108, 110. By way of example, the user device 106 may request a new account to be provided by the second external device 110 and may transmit the request to the universal account server 200 to effectuate opening of the new account. Similarly, in some embodiments, an external device 108, 110 may also may request a new account to be provided by the second external device 110 and may transmit the request to the universal account server 200 to effectuate opening of the new account. By way of example, a second financial institution associated with the second external device 110 may (e.g., based upon instruction from a user to be associated with the new account) transmit a request for a new account to the universal account server 200. In some other embodiments, the input/output circuitry 206 of the universal account server 200 may receive a request (e.g., via a direct user input or automatically) for a new account without input from the user device 106 or external device 108, 110.

As described above, in some embodiments, receiving the request for a new account at operation 305 may further require authentication of the request for a new account number. As would be evident to one of ordinary skill in the art in light of the present disclosure, a universal account number (UAN) of a particular user may be targeted for fraudulent activity. As such, the request at operation 305 may further require additional information from a user associated with the request as defined hereafter. By way of example, in some embodiments, the request at operation 305 may require the user to identify one or more account types provided by a current financial institution (e.g., first financial intuition) associated with the user. By way of a more particular example, in embodiments in which the request for a new account requires migrating funds from a current account in a first financial institution to a new account in a second financial institution, the universal account server 200 may require that the request for a new account also identify the number and/or type of accounts provided by the first financial institution. In some further embodiments, the universal account server 200 may, in addition to or alternatively, require a user to provide a password associated with the universal account number (UAN) of the user and/or a password associated with one or more current accounts of the user in the first financial institution. In some still further embodiments, as described above, the universal account number associated with each user may also comprise an encrypted token, certificate, or the like such that the request for a new account at operation 305 is authenticated by the nature of the encrypted token or certificate alone. In such an embodiment, the encrypted token or certificate may also be supplemented by the requirement of a user password or other user/account information in order to provide further increased security.

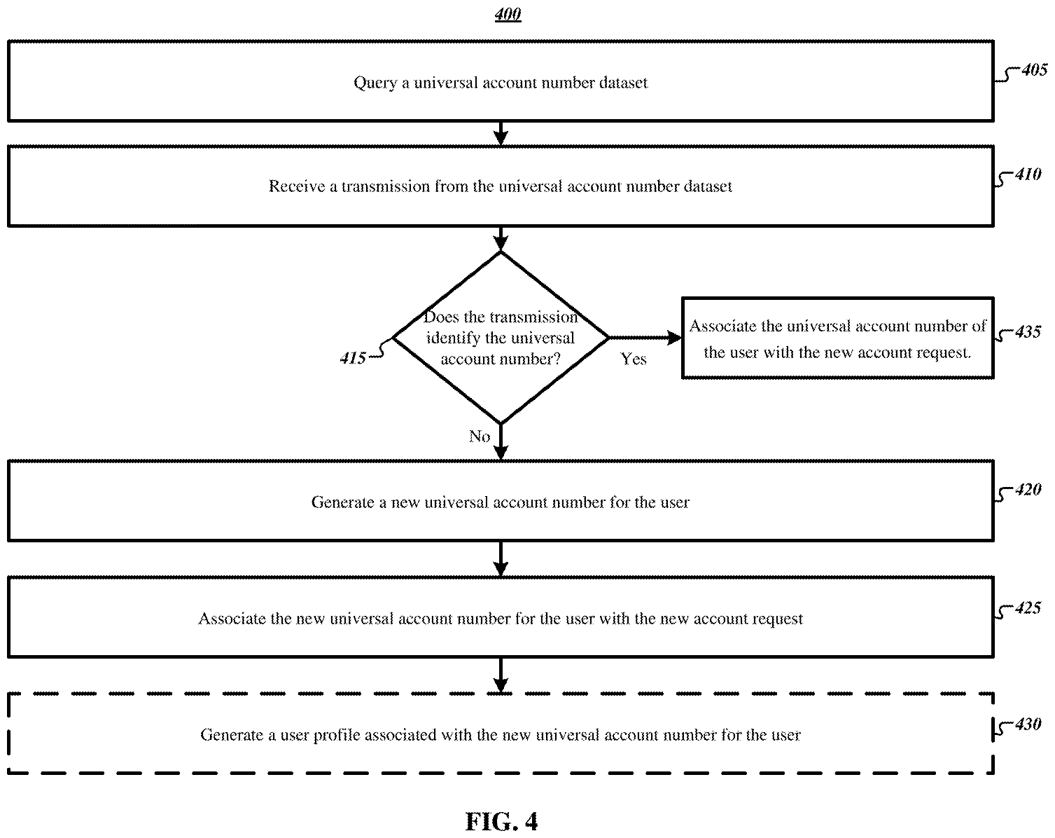

Thereafter, as shown in operation 310, the apparatus (e.g., universal account server 200) includes means, such as identification circuitry 212 or the like, for associating a universal account number of a user with the new account request. As described above, the universal account server 200 may associate a universal account number with a user that uniquely identifies the particular user requesting the new account such that each user is only associated with a single universal account number (UAN). As described more fully hereafter with reference to FIG. 4, the universal account server 200 may query a universal account number database (e.g., universal account number database 112 in FIG. 1) to receive a transmission that identifies the universal account number of the user requesting the new account. In some embodiments, the universal account number may be further tied to or associated with one or more other identifiers that uniquely identify a user (e.g., a social security number (SSN), unique identification identity (UID), or the like).

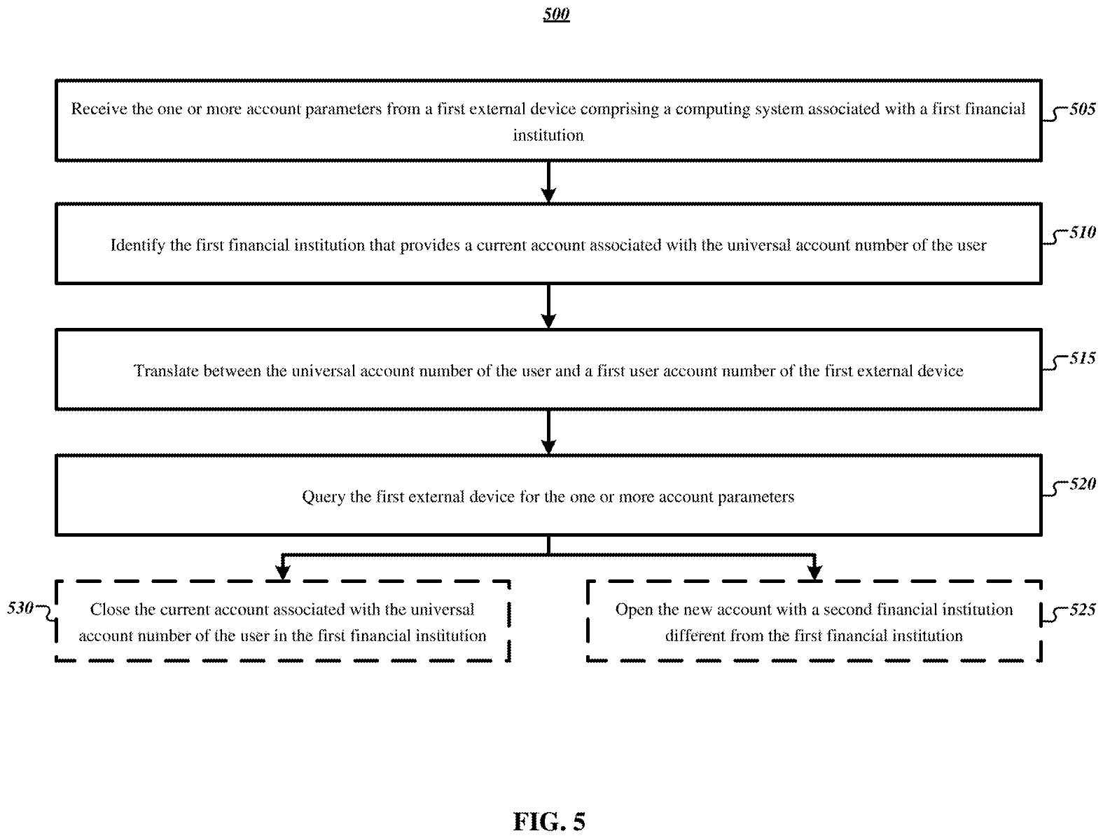

Thereafter, as shown in operation 315, the apparatus (e.g., universal account server 200) includes means, such as processor 202, memory 204, identification circuitry 212, or the like, for obtaining one or more account parameters associated with the universal account number (UAN) of the user. In some example embodiments, as described in greater detail below in connection with FIGS. 4-5, obtaining the one or more account parameters includes querying a remotely-stored universal account number database 112 storing one or more previously-determined or obtained account parameters associated with the universal account number of the user. In other embodiments where the universal account number data is not stored remotely, this operation may request these one or more account parameters from a memory (e.g., memory 204) locally storing the universal account number database 112. In some embodiments, the one or more account parameters stored by the universal account number database 112 may be populated by user inputs corresponding to the one or more account parameters (e.g., default account parameters). For example, the universal account server 200 may prompt the user (e.g., via a touchscreen display defined by the user device 106) to input one or more default account parameters (e.g., the type of user account, bill pay features, direct deposit instructions, or the like). By way of a more particular example, a user may input one or more default account parameters indicating that the user always opens a checking account and a savings account, and that the user always opens a savings account without a minimum balance. Because in some embodiments the universal account server 200 comprises the first user device 106, this operation may utilize the input/output circuitry 206 of the universal account server 200 itself in some cases.

In other embodiments, as described below with reference to FIG. 5, a current account of the user provided by a first financial institution (e.g., associated with first external device 108) may also include one or more account parameters associated with the universal account number (UAN) of the user via association with the current account of the user in the first financial institution. By way of example, a current savings account of a user provided by the first financial institution may include account parameters relating to bill pay features, direct deposit instructions, or the like. As such, the universal account server 200 may obtain one or more account parameters associated with the universal account number of the user at operation 315 by querying the first external device 108 associated with the first financial institution and receiving a corresponding responsive transmission from the first external device 108 providing the one or more account parameters.

Thereafter, as shown in operation 320, the apparatus (e.g., universal account server 200) includes means, such as processor 202, memory 204, compatibility circuitry 210, or the like, for determining one or more new account parameters associated with the new account. In some example embodiments described above, the financial institution ultimately providing the new account for the user (e.g., a second financial institution associated with second external device 110) may not provide account parameters equivalent to the one or more account parameters associated with the universal account number (UAN) of the user. By way of example, a current account of a user provided by a first financial institution may provide a checking account that does not require a minimum balance. However, the request for a new account may instruct the universal account server 200 to open the new account in the second financial institution associate with the second external device 110, where the checking accounts of the second financial institution require a minimum balance. In such an embodiment, compatibility circuitry 210 of the universal account server 200 may determine one or more new account parameters that are substantially equivalent to the one or more account parameters associated with the universal account number (e.g., the current user account). By way of continued example, the compatibility circuitry 210 may be configured to identify a checking account offered by the second financial institution having the lowest required minimum balance and may open the new account with the one or more new account parameters (e.g., the checking account with the lowest required minimum balance) as described hereafter at operation 325.

While described herein with reference to compatibility between a current account provided by a first financial institution and a new account in a second financial institution, the compatibility circuitry 210 of the universal account server 200 may equally determine one or more new account parameters that are equivalent to the one or more default account parameters inputted by a user. In some further embodiments, the universal account server 200 may further determine that, in an instance in which the second financial institution fails to provide account parameters that are equivalent with the account parameters of the first financial institution, the new account in the second financial institution may be provided with the one or more account parameters of the current account(s). Said differently, the second financial institution (e.g., via the universal account sever 200) may determine to offer a new account with new account parameters equivalent to the one or more account parameters associated with the current account to the user (e.g., so as to attract new account openings, users, or the like).

Furthermore, in some instances, the one or more new account parameters may be equivalent to the one or more account parameters associated with the universal account number (UAN) of the user such that compatibility determinations are unnecessary (e.g., financial institutions providing equivalent accounts). In some embodiments, however, the compatibility circuitry 210 of the universal account server 200 may be configured to determine one or more new account parameters in instances in which equivalent parameters and accounts are provided by the financial institution to provide the new account. Said differently, in such an embodiment, the compatibility circuitry 210 may determine one or more new account parameters that are improvements over the one or more account parameters associated with the universal account number of the user. By way of example, one or more account parameters associated with the universal account number of the user via parameters of a current account provided by a first financial institution may provide for an interest rate (e.g., on a mortgage or other financial product) that is greater than an interest rate offered by a new account in the second financial institution. As such, the compatibility circuitry 210 of the universal account server 200 may determine a new account parameter associated with the lower interest rate. In such an embodiment, the universal account server 200, via communications circuitry 208 or the like, may transmit a notification to a user and/or request confirm of the user regarding the new account parameter. In any embodiment, the one or more account parameters associated with the universal account number may be replaced, by the identification circuitry 212, with the one or more new account parameters associated with the new account.

Thereafter, as shown in operation 325, the apparatus (e.g., universal account server 200) includes means, such as processor 202, memory 204, communications circuitry 208, or the like, for causing the new account to be opened with the one or more new account parameters. In some example embodiments, the universal account server 200 may transmit instructions to a financial institution (e.g., second external device 110) to open the new account with the one or more new account parameters. In some embodiments, the universal account server 200 may further, via the communications circuitry 208, transmit a notification to the user device 106 of the new account opening, and, in some embodiments, may request confirmation from the user device 106 to open the new account. In some embodiments described more fully with reference to FIG. 5, causing the new account to be opened may further include closing the current account associated with the universal account number in the first financial institution and transferring any funds from the current account into the new account.

Turning next to FIG. 4, a flowchart is shown that describes example embodiments for associating a universal account number (UAN) with a user and generating a new universal account number for the user. The operations illustrated in FIG. 4 may, for example, be performed by, with the assistance of, and/or under the control of an apparatus (e.g., universal account server 200), as described above. In this regard, performance of the operations may invoke one or more of processor 202, memory 204, input/output circuitry 206, communications circuitry 208, identification circuitry 212, compatibility circuitry 210, and/or translation circuitry 214.

In operation 405, the universal account server 200 may further include means, such as the input/output circuitry 206, communications circuitry 208, or the like for querying a universal account number database. As described above, the universal account server 200 may transmit a request to a universal account number database 112 that may be hosted by the universal account server 200 or otherwise hosted by devices in communication with the universal account server 200. In operation 410, the universal account server 200 may further include means, such as the input/output circuitry 206, communications circuitry 208, or the like for receiving a transmission from the universal account number database in response to the query at operation 405. This responsive transmission, at operation 415, may be analyzed by the universal account server 200 (e.g., the identification circuity 212) to determine if the transmission identifies the universal account number (UAN) of the user associated with the new account request. As would be evident to one of ordinary skill in the art in light of the present disclosure, any given universal account number stored by the universal account number database 112 uniquely identifies only a single user. As such, the determination at operation 415 may be such that either a universal account number is received by the universal account server 200 or not. At operation 435, in an instance in which the transmission from the universal account server identifies the universal account number of the user, the universal account server may associate the universal account number of the user with the new account request as described above with reference to operation 310 in FIG. 3.

Thereafter, as shown in operation 420, the apparatus (e.g., universal account server 200) includes means, such as processor 202, memory 204, communications circuitry 208, identification circuitry 212, or the like for, in an instance in which the transmission from the universal account number database 112 fails to identify the universal account number (UAN) of the user, generating a new universal account number for the user. In some embodiments, such as instances in which a user has yet to utilize the universal account server features described here, the user may not be associated with a universal account number that uniquely identifies the user. As such, in an instance in which the universal account server 200 determines (e.g., via identification circuitry 212 or the like) that a universal account number for the user is not present, a new universal account number is generated and, at operation 425, is associated with the respective user. In this way, the request for a new account by the user is now associated with a universal account number such that the operations of FIG. 3 regarding opening of the new user account may be performed.

With reference to operation 430, in some embodiments, the apparatus (e.g., universal account server 200) includes means, such as processor 202, memory 204, identification circuitry 208, compatibility circuitry 210, or the like, for generating a user profile associated with the new universal account number (UAN) for the user. As described above with reference to the one or more account parameters obtained at operation 315 in FIG. 3, the user profile may comprise the one or more account parameters to be stored by the universal account number database 112. In some embodiments, the one or more account parameters may be populated by user inputs corresponding to the one or more account parameters of the user profile. For example, the universal account server 200 may prompt the user (e.g., via a touchscreen display defined by the user device 106) to input one or more default account parameters for the user profile (e.g., the type of user account, bill pay features, direct deposit instructions, or the like). As described above, a user may input one or more default account parameters indicating that the user always opens a checking account and a savings account, and that the user always makes direct deposits into the savings account and always pay bills from the checking account.

Turning next to FIG. 5, a flowchart is shown that describes example embodiments for transitioning between a first financial institution providing a current user account and a new account provided by a second financial institution. The operations illustrated in FIG. 5 may, for example, be performed by, with the assistance of, and/or under the control of an apparatus (e.g., universal account server 200), as described above. In this regard, performance of the operations may invoke one or more of processor 202, memory 204, input/output circuitry 206, communications circuitry 208, identification circuitry 212, compatibility circuitry 210, and/or translation circuitry 214.

As shown in operation 505, the universal account server 200 may further include means, such as the identification circuitry 212, translation circuitry 214, or the like for receiving the one or more account parameters described above from a first external device comprising a computing system associated with a first financial institution. As described in reference above in reference to operations 315 and 320 in FIG. 3, a current account associated with the universal account number (UAN) may provide one or more account parameters for use by the universal account server 200. In particular, the first external device 108 may comprise a computing system associated with a first financial institution providing a current account to a user. In this instance, the current account includes one or more account parameters associated with the user, and, by extension, the universal account number of the user. At operation 510, the universal account server 200 may further include means, such as the identification circuitry 212, translation circuitry 214, or the like for identifying the first financial institution that provides a current account associated with the universal account number of the user. By identifying the financial institution, the universal account server 200 may query and receive the one or more account parameters of the current account as described hereafter.

Thereafter as shown in operations 515 and 520, the universal account server 200 may further include means, such as the communications circuitry 208, translation circuitry 214, or the like for translating between the universal account number (UAN) of the user and a first user account number of the first external device and querying the first external device for the one or more account parameters. By way of example, the first external device 108 and associated computing systems associated with a first financial institution may, in some embodiments, utilize an account identification system, account numbering protocol, or the like that differs from the universal account number. In this way, an account number or parameter of a user and/or user profile in the first external device 108 may be different from the universal account number and associated account parameters of the universal account number. As such, the translation circuitry 214 may be configured to convert or translate between account number data received from the first external device 108 and the universal account number associated with the particular user. This translation may enable the first external device 108 to maintain current or long-used account data protocols while also allowing the functionality of the universal account server 200. Said differently, this translation operation at 515 may operate to allow retrofitting external devices (e.g., computing systems) of financial institutions to accommodate the emerging technologies and functionality provided by the universal account server 200 without extensive changes to the systems of a financial institution. As describe above, the translation circuitry 214 may be optional insofar as some embodiments may not require conversion or translation between account data of an external device (e.g., account data of a financial institution) and the universal account number associated with a user.

As shown in operation 525, the apparatus (e.g., universal account server 200) includes means, such as communications circuitry 208, input/output circuitry 206, or the like, for, in some embodiments, opening the new account with a second financial institution different from the first financial institution as described above at operation 325 in FIG. 3. By way of example, the universal account server 200 may transmit an instruction to the second external device 110 comprising a computing system associated with a second financial institution requesting that the new account be opened in the second financial institution. Similarly, as shown in operation 530, the apparatus (e.g., universal account server 200) includes means, such as communications circuitry 208, input/output circuitry 206, or the like, for, in some embodiments, closing the current account associated with the universal account number (UAN) of the user in the first financial institution. As would be evident to one of ordinary skill in the art in light of the present disclosure, the request for opening a new account (e.g., transmitted by a user device 106 or otherwise) may further include instructions for closing a current account prior to, simultaneous with, or after opening the new account. In some embodiments, receiving the request for the new account (e.g., at operation 305 in FIG. 3) may further include receiving instructions for closing the current account associated with the universal account number of the user in the first financial institution.

As described above concerning authentication, the method may further include authenticating the instructions for closing the current account (e.g., via requiring an encrypted token, user password input, etc.) and causing the current account to be closed in the first financial institution at operation 530. In some embodiments, closing the current account in the first financial institution at operation 530 and opening the new account with a second financial institution at operation 525 may further require one or more balancing operations. In some example embodiments, the second financial institution may accept the deposits and dues of the current account in the first financial institution, and, upon receipt from the user, may transfer funds in satisfaction of these dues to the first financial institution (e.g., or a third-party). In some other embodiments, the universal account server 200 may determine, via analyzing one or more account parameters and/or a user profile of the user associated with the current account, that the migration of the current account in the first financial institution to the second financial institution may not occur until outstanding dues are paid to the first financial institution. For example, in an instance in which the user profile indicates that the user has a low credit score or is otherwise at risk for nonpayment, the universal account server 200 may require the user to pay the outstanding dues to the first financial institution before allowing migration of the account to the second financial institution.

As described above, various technical challenges are surmounted via technical solutions contemplated herein. For instance, the use of a uniquely-identifiable universal account number (UAN) provides for increased bank number account portability (BANP) by allowing a user to (1) open a new account in an financial institution, (2) transfer accounts between institutions, and (3) open new accounts with equivalent or improved account parameters without required contact with any institution associated with the request. Furthermore, a universal account number that uniquely identifies particular users may also function to increase account security by providing uniform protection for all users regardless of financial institution selected. Embodiments of the present disclosure provide improved account portability techniques by associating requests for new accounts with a universal account number of a user where the universal account number uniquely identifies the particular user. This universal account number may be utilized to obtain account parameters associated with the universal account number (e.g., by default or received from a financial institution providing a current account), determine one or more new account parameters, and open the new account with the new parameters.

FIGS. 3-5 thus illustrate flowcharts describing the operation of apparatuses, methods, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 204 of the universal account server 200 and executed by a processor 202 of the universal account server 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for improved account portability, the method comprising:
receiving, by a computing device, a request for a new account;
associating, by identification circuitry of the computing device, a universal account number of a user with the request for the new account, wherein the universal account number uniquely identifies the user;
obtaining, by the identification circuity of the computing device, one or more account parameters associated with the universal account number of the user;
determining, by compatibility circuity of the computing device, one or more new account parameters associated with the new account; and
causing the new account to be opened with the one or more new account parameters.

2. The method according to claim 1, wherein associating the universal account number with the new account request comprises:
querying, by the identification circuitry of the computing device, a universal account number database;
in response to querying the universal account number database, receiving a transmission from the universal account number database;
in an instance in which the transmission from the universal account number database fails to identify the universal account number of the user,
generating, by the identification circuitry, a new universal account number for the user, and
associating the new universal account number for the user with the new account request; and
in an instance in which the transmission from the universal account number database identifies the universal account number of the user, associating the universal account number of the user with the new account request.

3. The method according to claim 2, further comprising, in response to generating the new universal account number for the user, generating a user profile associated with the new universal account number for the user.

4. The method according to claim 1, wherein obtaining one or more account parameters associated with the universal account number of the user comprises:
receiving, by input/output circuitry of the computing device, one or more account parameters inputs; and
populating, by the identification circuitry, the user profile with the one or more account parameters inputs.

5. The method according to claim 1, wherein obtaining the one or more account parameters further comprises receiving, by the identification circuitry, the one or more account parameters from a universal account number database.

6. The method according to claim 1, wherein obtaining the one or more account parameters further comprises receiving the one or more account parameters from a first external device, wherein the first external device comprises a computing system associated with a first financial institution providing a current account associated with the universal account number of the user.

7. The method according to claim 6, further comprising:
identifying the first financial institution that provides the current account associated with the universal account number of the user;
translating, by translation circuitry of the computing device, between the universal account number of the user and a first user account number of the first external device; and
querying, by the identification circuitry, the first external device for the one or more account parameters, wherein the one or more account parameters are obtained in response to querying the first external device.

8. The method according to claim 6, wherein the request for the new account comprises instructions for opening the new account with a second financial institution different from the first financial institution.

9. The method according to claim 8, wherein receiving the request for the new account further comprises:
receiving instructions for closing the current account associated with the universal account number of the user in the first financial institution;
authenticating the instructions for closing the current account; and
causing the current account to be closed in the first financial institution.

10. The method according to claim 1, further comprising replacing, by the identification circuitry of the computing device, the one or more account parameters associated with the universal account number with the one or more new account parameters associated with the new account.

11. An apparatus for providing improved account portability, the apparatus comprising:
communications circuitry configured to:
receive a request for a new account; and
cause the new account to be opened with one or more new account parameters;
identification circuitry configured to:
associate a universal account number of a user with the request for the new account, wherein the universal account number uniquely identifies the user; and
obtain one or more account parameters associated with the universal account number of the user; and
compatibility circuity configured to determine the one or more new account parameters associated with the new account.

12. The apparatus according to claim 11, wherein the identification circuitry is further configured to:
query a universal account number database;
in response to querying the universal account number database, receive a transmission from the universal account number database;
in an instance in which the transmission from the universal account number database fails to identify the universal account number of the user,
generate a new universal account number for the user, and
associate the new universal account number for the user with the new account request; and
in an instance in which the transmission from the universal account number database identifies the universal account number of the user, associate the universal account number of the user with the new account request.

13. The apparatus according to claim 12, wherein, in response to generating a universal account number for the user, the identification circuitry is further configured to generate a user profile associated with the new universal account number for the user.

14. The apparatus according to claim 12, further comprising input/output circuitry configured to receive one or more account parameter inputs.

15. The apparatus according to claim 11, wherein the identification circuitry is further configured to receive the one or more account parameters from a universal account number database.

16. The apparatus according to claim 11, wherein the communications circuitry is further configured to receive the one or more account parameters from a first external device, wherein the first external device comprises a computing system associated with a first financial institution providing a current account associated with the universal account number of the user.

17. The apparatus according to claim 16, further comprising translation circuitry configured to:
identify the first financial institution that provides the current account associated with the universal account number of the user; and
translate between the universal account number of the user and a first user account number of the first external device.

18. The apparatus according to claim 17, wherein the identification circuitry is further configured to query the first external device for the one or more account parameters, wherein the one or more account parameters are obtained in response to querying the first external device.

19. The apparatus according to claim 16, wherein the request for the new account further comprises instructions for opening the new account with a second financial institution different from the first financial institution.

20. A non-transitory computer-readable storage medium for using an apparatus to provide improved account portability, the non-transitory computer-readable storage medium storing instructions that, when executed, cause the apparatus to:
receive a request for a new account;
associate a universal account number of a user with the request for the new account;
obtain one or more account parameters associated with the universal account number of the user;
determine one or more new account parameters associated with the new account; and
cause the new account to be opened with the one or more new account parameters.
